(19) United States
(12) Patent Application Publication
(10) Pub. No.: US 2003/0086485 A1
(43) Pub. Date: May 8, 2003

(54) Master to multi-slave asynchronous transmit fifo

(76) Inventors: John Lin, Downey, CA (US); Vivian Chou, Torrance, CA (US)

Correspondence Address: James A. Harrison, P.O Box 670007, Dallas, TX, 75367, US

(21) Appl. No.: 10/008,872

(22) Filed: Nov. 8, 2001

(51) Int. Cl. H04B 1/38; H04L 5/16

(52) U.S. Cl. 375/219

(57) ABSTRACT

A baseband controller system includes a master to a multi-slave asynchronous transmit FIFO structure that enables the traffic to all slaves to be independent of each other in a manner that reduces the shortcomings of traditional FIFO structures. The inventive FIFO structure includes a plurality of pointer blocks wherein each of the FIFO pointer blocks comprises a plurality of one-byte pointers that point to command blocks. The command blocks, in turn, define an address that point to a starting address of a data block. Accordingly, because the FIFO pointer blocks only include an address for a pointer to a command block instead of the actual data that is to be transmitted, the size of the FIFO structure is dramatically reduced. Thus, the transmission order for the data blocks is determined by ordering the pointers instead of by ordering the data itself.

### BACKGROUND

1. Technical Field

The present invention relates to wireless communication systems and, more specifically, to wireless communication baseband controllers for systems utilizing master to multi-slave communications.

2. Related Art

The Bluetooth wireless technology allows users to make effortless, wireless and instant connections between various communication devices such as notebook computers, desktop computers and mobile phones. Because Bluetooth systems use radio frequency transmissions to transfer both voice and data, the transmissions occur in real-time. The Bluetooth specification provides for a sophisticated transmission mode that ensures protection from interference and provides security of the communication signals.

According to most designs that implement the Bluetooth specifications, the Bluetooth radio is being built into a small microchip and is designed to operate in frequency bands that are globally available. This ensures communication compatibility on a worldwide basis. Additionally, the Bluetooth specification defines two power levels. A first power level covers the shorter, personal area within a room and a second power level is designed for covering a medium range. For example, the second power level might be used to cover communications from one end of a building, such as a house, to the other. Software controls and identity coding are built into each microchip to ensure that only those units preset by the owners can communicate with each other.

More specifically, the Bluetooth wireless technology supports point-to-point and point-to-multipoint connections. Under the Bluetooth specifications, one master can communicate with up to seven slave devices. At any one instant, a Bluetoodh master can communicate or transmit over three channels to the slaves under current specifications and designs. Additionally, one group of Bluetooth devices, namely a master and a plurality of slaves, may also communicate with another group to create communication networks of continually configurable and flexible configurations. The topology is best described as a flexible and extendible micronetwork.

The Bluetooth specification is made to facilitate compatibility among systems made by different vendors and sold and utilized throughout the world. At the same time, the Bluetooth protocols and specifications are open to enable the use of proprietary processes underneath the defined communication protocols. The Bluetooth protocol stack can be divided into four layers, notwithstanding that it allows for proprietary implementation, according to the purposes and aspects of the protocol. For example, the core Bluetooth protocol defines the protocols for baseband operation, as well as the link manager protocol (LMP), logical link and control adaptation protocol (L2CAP), and service discovery protocol (SDP).

The second protocol layer is the cable replacement protocol that includes the serial cable emulation protocol (RSCOMM). The third protocol layer is the telephony control protocols which includes the telephony control specification (TCS binary) and the AT commands. Finally, the fourth protocol layer includes the adopted protocols, such as point-to-point protocol (PPP), transport control protocol/user datagram protocol (TCP/UDP), object exchange protocol (OEP), wireless application protocol (WAP), WAP application environment (WAE) and others. In addition to the above mentioned protocol layers, the Bluetooth specification also defines a host controller interface (HCI). HCI provides a command interface to the baseband controller, link manager, as well as access to hardware status and control registers.

The Bluetooth core protocols include Bluetooth-specific protocols that have been developed for Bluetooth systems. For example, the RFCOMM and TCS binary protocol have also been developed for Bluetooth but they are based on the ETSI TS 07.10 and the ITU-T recommendations Q.931 standards, respectively. Most Bluetooth devices require the Bluetooth core protocols, in addition to the Bluetooth radio, while the remaining protocols are only implemented when necessary.

The cable replacement layer, the telephone control layer and the adopted protocol layer form application-oriented protocols that enable applications to run on top of or over the Bluetooth core protocols. Because the Bluetooth specification is open, these additional protocols may be accommodated in an inoperable fashion that is not necessarily required.

The baseband and link control layers facilitate the physical operation of the Bluetooth transceiver and, more specifically, the physical RF link between Bluetooth units forming a network. As the Bluetooth standards provide for frequency-hopping in a spread spectrum environment in which packets are transmitted in continuously changing defined time slots on defined frequencies, the basesband and link control layer utilizes inquiry and paging procedures to synchronize the transmission of communication signals at the specified frequency and clock cycles between the various Bluetooth devices.

The Bluetooth core protocols further provide two different types of physical links with corresponding baseband packets. A synchronous connection-oriented (SCO) and an asynchronous connectionless (ACL) physical link may be implemented in a multiplexed manner on the same RF link. ACL packets are used for data only while the SCO packets may contain audio, as well as a combination of audio and data. All audio and data packets can be provided with different levels of error correction and may also be encrypted if required. Special data types, including those for link management and control messages, are transmitted on a special specified channel.

The Bluetooth protocols are intended for rapidly developing applications using Bluetooth technology. These applications include an ultimate headset, three-in-one phone, local network access, file transfer and Internet bridge. Because of the different types of applications that are envisioned for Bluetooth systems, several aspects of the communication protocols are very important. One requirement for a Bluetooth device is to be able to communicate and transfer its signals in a real-time basis. Another requirement that is extremely important for a Bluetooth system is that it be able to transmit and receive and interpret transmissions at exact moments in time. In the context of a Bluetooth network that includes one master and seven slaves, the synchronization and timing requirements for the communications can be significant for any one device. Current micro-sequencers and controllers, for example, do not have the capability to communicate with up to seven slaves on a real-time basis because it is impossible for any one micro-controller to satisfy the real-time Bluetooth requirements. For example, the internal data pipelines and supporting hardware to facilitate such communications do not readily support this requirement that is found in the Bluetooth specification. Stated differently, the data pipeline designs of masters and micro-controllers cannot readily process all of the data for seven slaves on a real-time basis.

One particularly acute issue that is specific to Bluetooth, as well as to other systems, is that of temporarily storing data that is to be transmitted to any one of a plurality of devices. For example, in a Bluetooth network that can include seven slaves that are in communication with the master, the master must be able to store data for transmission for any one of the seven slaves.

Typically, the design approach is to use a first in, first out scheme for transmitting data to the plurality of devices. First in, first out (FIFO) architectures, however, are expensive structures in terms of resource utilization on a semiconductor device. In the case of a Bluetooth system, the FIFO design would have to accommodate enough memory space to store the communications for the seven slaves (worst case situation).

An additional problem that exists with common FIFO structures (especially Bluetooth) is that traffic to a given device must be re-transmitted whenever a transmission failure occurs due to interference or any other reason. Accordingly, in a traditional system in which a contiguous memory includes a plurality of data blocks that are transmitted to one or more slaves on a first in, first out basis, the requirement for a transmission to be repeated causes subsequent transmissions to be delayed until the transmission that encountered the error is successfully received by the destination device. Because of this, common FIFO structures can cause significant delay. Accordingly, what is needed is a device that provides the ability for a master to communicate with up to seven other devices concurrently and on a real-time basis while satisfying Bluetooth timing requirements.

### SUMMARY OF THE INVENTION

A baseband controller system includes a master to a multi-slave asynchronous transmit FIFO structure that enables the traffic to all slaves to be independent of each other in a manner that reduces the shortcomings of traditional FIFO structures. The inventive FIFO structure includes a plurality of pointer blocks that, in turn, include a plurality of one-byte pointers to address portions that, in turn, point to portions of memory containing data that is to be transmitted on a first in, first out basis. More specifically, each of the FIFO pointer blocks comprises a plurality of one-byte pointers that point to command blocks. The command blocks, in turn, define an address that point to a starting address of a data block. Accordingly, because the FIFO pointer blocks only include an address for a pointer to a command block instead of the actual data that is to be transmitted, the size of the FIFO structure is dramatically reduced.

Each of a plurality of command blocks that define the address to a data block that is to be transmitted further include a corresponding one-bit indicator that defines whether the command block is in use. Thus, as a controller seeks to utilize a command block to point to a data block, it examines the one-bit indication for each of the command blocks to find one that is not in use. In the actual priority for the first in, first out data transmission, processing is defined by the FIFO pointer blocks. Because each FIFO pointer block includes a plurality of one-byte pointers to the command blocks that in turn point to the actual data blocks, the priority of data may be specified by arranging the order of one-byte pointers within the FIFO pointer blocks.

Other aspects of the present invention will become apparent with further reference to the drawings and specification, which follow.

### BRIEF DESCRIPTION OF THE DRAWINGS

These and other features, aspects and advantages of the present invention will be more fully understood when considered with respect to the following detailed description, appended claims and accompanying drawings wherein:

FIG. 1 is a system diagram illustrating a number of Wireless Personal Area Network (WPAN) electronic devices that wirelessly communicate according to the present invention;

FIG. 2 is a functional block diagram of a Bluetooth radio modem formed according to one embodiment of the present invention;

FIG. 3 is a flowchart illustrating a method for storing and accessing data that is to be transmitted through a radio modem according to one embodiment of the present invention;

FIG. 4 is a functional block diagram illustrating a traditional prior art FIFO memory structure;

FIG. 5 is a functional schematic block diagram of a microsequencer configured as a real-time Bluetooth baseband controller;

FIG. 6 is a functional block diagram illustrating a plurality of memory structures formed according to one embodiment of the present invention; and

FIG. 7 is a functional block diagram illustrating one embodiment of memory structures formed and configured according to the present invention.

### DETAILED DESCRIPTION OF THE DRAWINGS

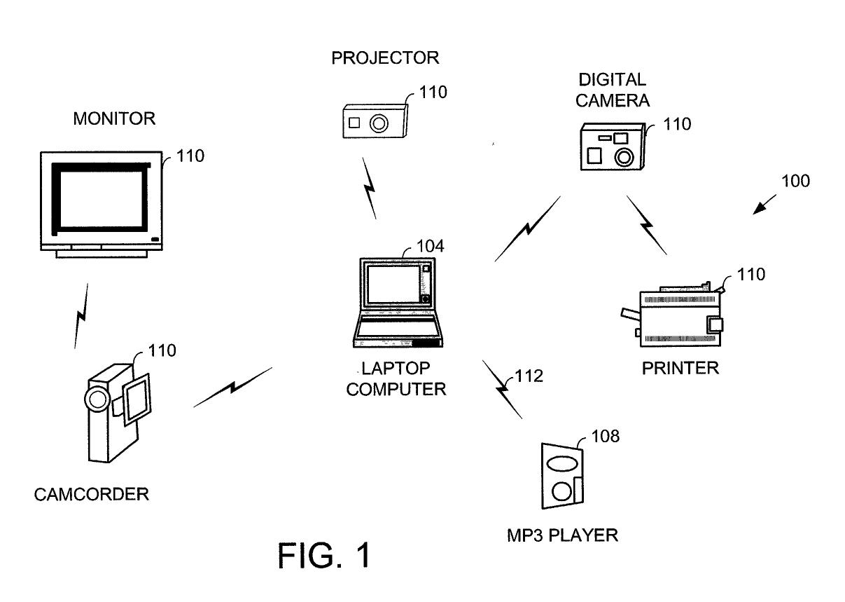

FIG. 1 is a functional block diagram of a Bluetooth micro network formed according to one embodiment of the present invention. As may be seen, a Bluetooth master 104 communicates with a plurality of slaves 108 and 110. More specifically, master 104 communicates with slave 108 over communication link 112. Each of the previously mentioned communication layer exchanges may occur between master 104 and the slaves 108 and 110 at any time. Additionally, any one of the slave devices, such as slave 108, may execute each of the aforementioned applications. For example, one slave might be a camcorder, a computer monitor, an MP3 player, a speaker or set of speakers, a printer, a projector or a wireless modem (not shown here in FIG. 1). As may be seen, one Bluetooth network is able to not only transmit audio signals for speakers to play for entertainment purposes, but also to transmit data signals to a specified communication device to enable the user to “surf” the web while listening to his/her favorite music.

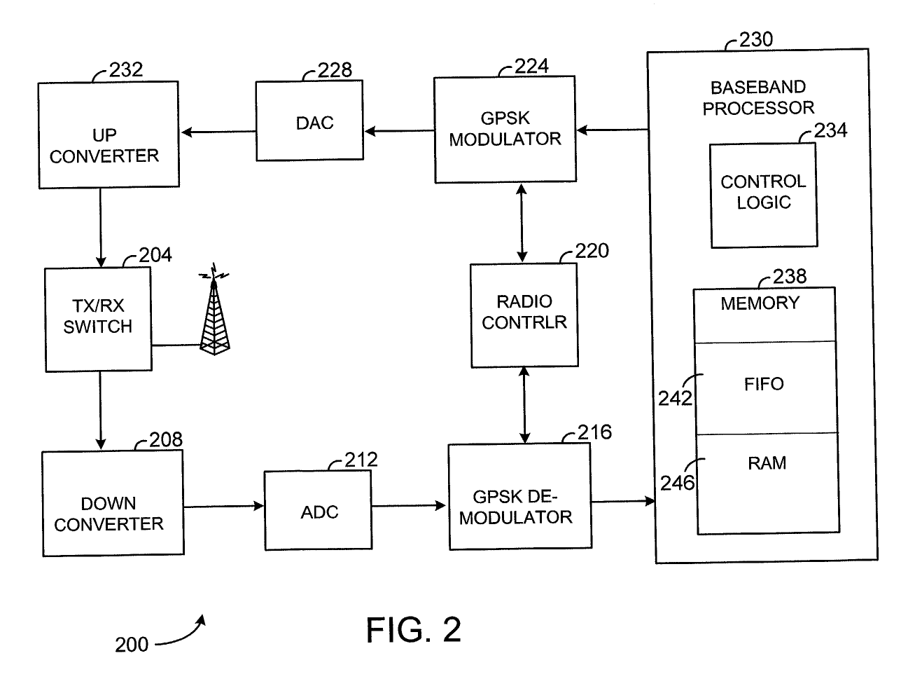

FIG. 2 is a functional block diagram of a Bluetooth radio modem formed according to one embodiment of the present invention. Referring to the Bluetooth radio modem 200, the radio modem includes a transmit/receive switch 204 that is coupled to an antennae for transmitting and receiving radio frequency signals. For radio frequency signals that are received, the transmit/receive switch 204 is coupled to a down converter 208 that converts the received radio frequency signals to baseband frequency signals. In one embodiment of the present invention, down converter 208 converts directly from RF to baseband, while in another embodiment of the invention, the down conversion occurs through an intermediate frequency step. The down converted radio signals are then produced to an analog-to-digital converter 212 that converts the analog baseband signal to digital. The converter digital signal is then produced to a demodulator 216 which, in the described embodiment of the invention, is a GPSK demodulator. Any type of known modulation scheme may be used, however. The GPSK demodulator 216 then produces the demodulated digital signal to baseband processing circuitry for processing. The GPSK demodulator 216 further is coupled to a radio controller 220 that controls the demodulation signals. Radio controller 220 further is coupled to a GPSK modulator 224 that modulates signals that are to be transmitted, which signals are received from a baseband processor. The modulated signals are then produced by GPSK modulator 224 to a digital-to-analog converter 228 that, in turn, produces converted analog signals at a baseband frequency to up converter 232 that, in turn, converts the signal back to RF for transmission. Thus, up converter 232 produces its output to transmit/received switch 204 that then transmits the signal from its antennae coupled thereto.

The present invention is part of the baseband processing circuitry that receives the demodulated signal from GPSK demodulator 216 and that produces baseband signals to GPSK modulator 224 for processing and transmission. Thus, one aspect of the present is invention relates to the order of data that is to be produced to GPSK modulator 224.

Baseband processing circuitry 230, as may be seen, includes a control logic module 234, as well as memory shown generally at 238. The memory shown generally at 238 includes a first in, first out memory structure 242 and a random access memory structure 246. According to the present embodiment of the invention, FIFO memory structure 242 is for controlling and providing access to actual data blocks that are stored within random access memory portion 246 in a manner that causes the data blocks to be transmitted in a first in, first out basis without requiring the data to actually be stored within the FIFO memory structure 242.

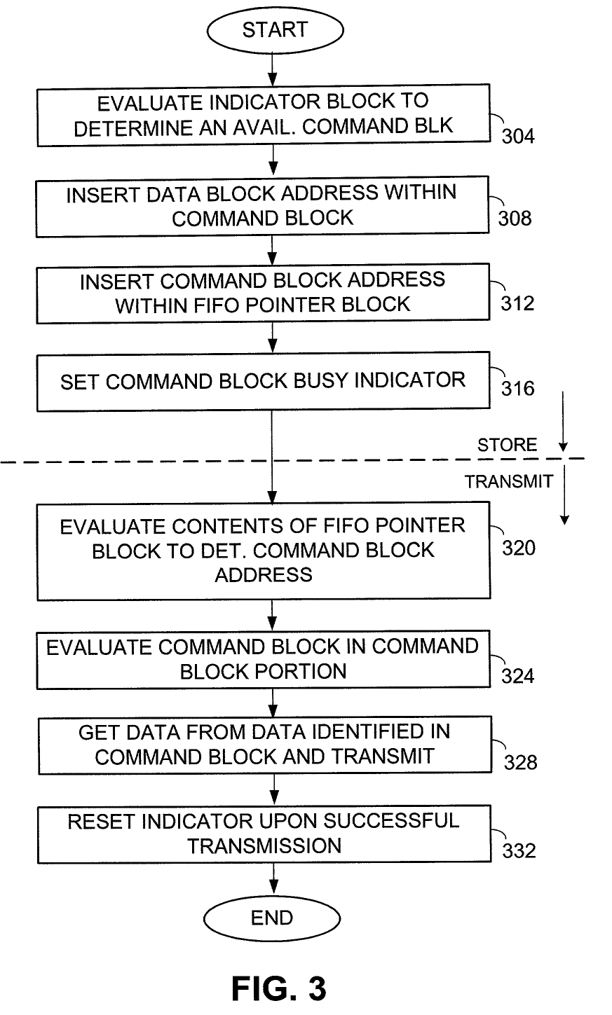

FIG. 3 is a flowchart illustrating a method for storing and accessing data that is to be transmitted through a radio modem according to one embodiment of the present invention. Initially, the invention includes evaluating an indicator block to determine whether a command block is available for storing an address to a data block that is to be transmitted (step 304). In general, step 304 includes evaluating more than one indicator blocks, if necessary, until an available command block is found. Once an available command block is found, a data block address is stored within the command block (step 308). Thereafter, the command block which received the data block address, which is identified by a command block address, has its command block address stored in a FIFO pointer block (step 312). The FIFO pointer block is a portion of a FIFO memory structure that is used for storing addresses of command blocks that, in turn, store addresses of data blocks. Once a data block address has been stored within a command block, a command block indicator is set to indicate that the command block is in use (step 316).

The foregoing steps describe a process for finding an available command block for identifying an address of a data block that is to be transmitted. The following part of the inventive process relates to transmitting the previously stored data. When a transmission for a given FIFO data block is to occur, the invention includes evaluating the contents of a FIFO pointer block within a FIFO structure to determine a command block address for the next data block that is to be transmitted (step 320). The process then involves evaluating a data block address that is stored within the command block in a command block portion as identified by the FIFO pointer block (step 324). At this point, the actual address in random access memory of the data has been identified and thus the process includes obtaining the data and transmitting it (step 328). Finally, upon determining that the data was successfully transmitted in step 328, the invention includes resetting the command block indicator so that the command block may be used to specify the address of a new data block that is to be transmitted.

As may be seen from the present method, the inventive method is advantageous in that, when coupled with the described structures herein, it facilitates a FIFO architecture in a master-multi-slave environment in which the size of the FIFO structure is minimized because the FIFO structure is used to contain pointer addresses rather than actual blocks of data. The pointer addresses then point to a command block that actually points to the data itself. Also, while not specifically stated in the above process, it is understood that the step of getting the data and transmitting includes evaluating an initial portion of the data block, as specified by the data block address, to determine the size of the data block that is to be transmitted. Accordingly, the system that is transmitting the data is able to know how much data is to be transmitted and to allocate corresponding resources thereto.

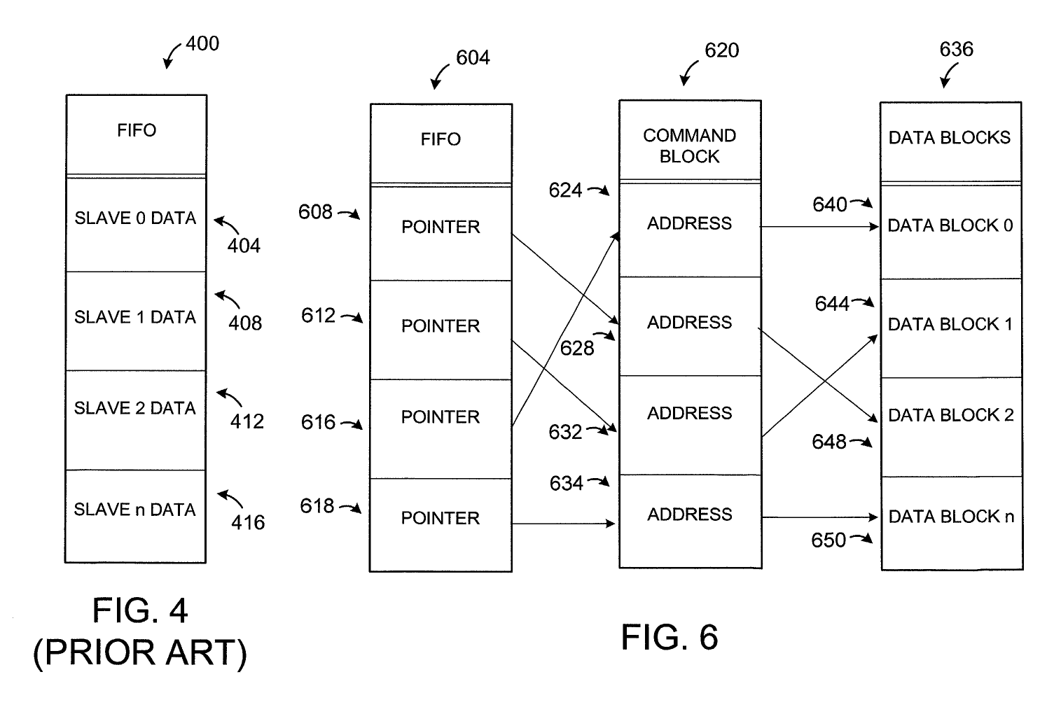

FIG. 4 is a functional block diagram illustrating a traditional prior art FIFO memory structure. As may be seen, a FIFO memory structure 400, in the example shown, defines four memory allocations for saving data that is intended for any one of a plurality of slave devices. More specifically, memory portion 404 is allocated to storing data for slave #0, while memory portion 408 is for storing data for slave #1, while memory portion 412 is for storing data for slave #2 and memory portion 416 is for storing data for slave “n”. Slave “n” represents any and all of the remaining slaves according to whether any particular slave has data that is to be transmitted.

Assuming, for example, that the data comes off the upper end of the FIFO memory structure 400, slave #2 data cannot be transmitted until slave #1 data has been transmitted successfully. Accordingly, an error encountered due to interference or other transmission problem during the transmission of the slave #1 data stored in memory portion 408, would result in a delay being experienced in the transmission of each of the other data blocks stored and shown in FIG. 4.

Additionally, a negative aspect of the FIFO memory structure 400 is that such a structure is large compared to most FIFO structures because it is designed for use in a master-to-multi-slave transmission environment. Because each of the slave devices could potentially require the storage of significantly sized blocks of data, the FIFO structure must be made large in order to be sufficiently robust and able to meet transmission requirements.

While FIG. 4 illustrates a FIFO structure that is contiguous for all of the slaves in a master-multislave network configuration, there are other topologies that are possible. For example, some possible designs include forming a plurality of FIFO memory structures, one for each potential slave. While this design helps solve the problem of transmission errors to one slave affecting the transmission to other slaves, such a design still is inefficient and expensive. This approach requires that each FIFO structure be built to accommodate all of the data that might be required to be transmitted. Accordingly, this structure requires the creation and reservation of resources for an extreme situation that may rarely come to pass. Most of the FIFO structures would frequently be utilized at a low percentage of their capacities because they are designed to capture the extreme circumstances.

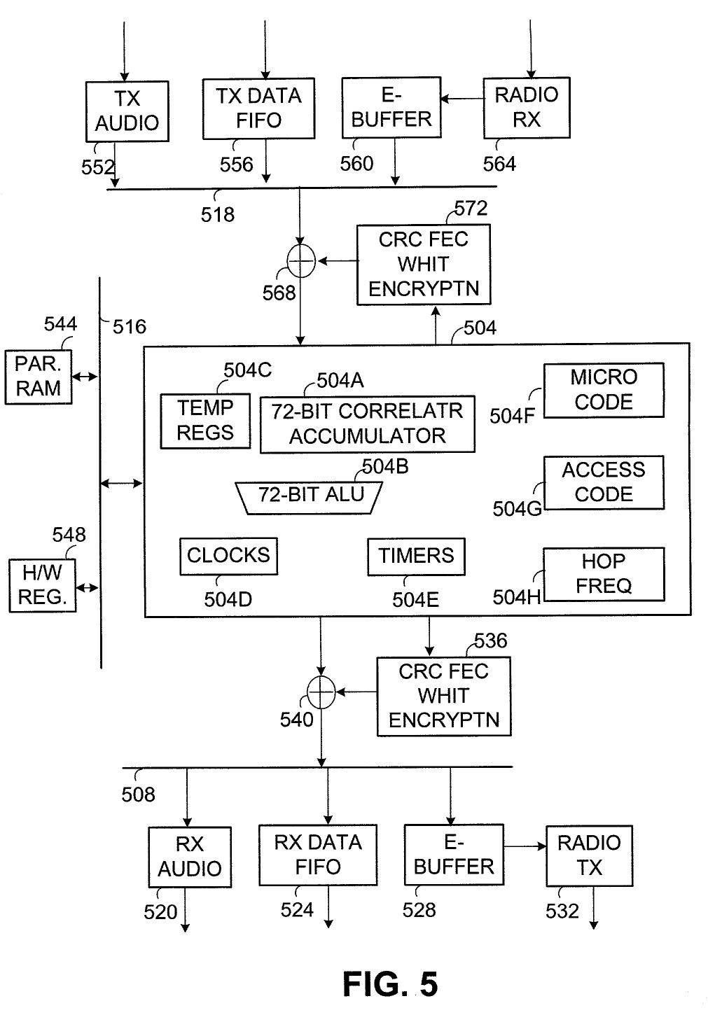

FIG. 5 is a functional schematic block diagram of a microsequencer configured as a real-time Bluetooth baseband controller. A microsequencer circuit 500 in which the microsequencer is configured as a real-time Bluetooth baseband controller includes a microsequencer 504 that is coupled to a plurality of devices. More specifically, as may be seen, microsequencer 504 is coupled to a plurality of buses 508, 518 and 516 that enables it to communicate with registers, memory and other circuitry. For example, bus 508 is coupled to RX audio circuitry 520, RX data FIFO 524 and E-Buffer 528. E-Buffer 528 further is coupled to radio TX block 532. RX audio circuitry 520, RX data FIFO 524 are for receiving received audio processed by the microsequencer. E-Buffer 528 and radio TX 532 are for transmitting radio signals.

The microsequencer 504 of FIG. 5 includes a 72-bit correlator/accumulator 504A, a 72-bit arithmetic logic unit 504B and temporary registers 504C in the diagram shown herein. Microsequencer 504 further includes clock circuitry 504D and timer circuitry 504E for providing timing control functionality to facilitate satisfaction of Bluetooth requirements. The functionality of the clocks and timers are, in the described embodiment of the invention, similar to that which has been described elsewhere herein. Microsequencer 504 further includes microcode block 504F that is for storing microcode (operational computer instructions), access code block 504G that is for storing sync codes and hop frequency block 504H that is for storing frequency information.

Microsequencer 504 also is coupled to CRC FEC Whiten encryption modules 536 and 572 that are for providing CRC error detection, error correction and “whitening” of a given stream of digital signals. The outputs of modules 536 and 572 are coupled to logic gates (exclusive OR in the described embodiment) which combines their outputs with data being output from or input to microsequencer 504.

Parameter RAM block 544 and hardware registers block 548 are coupled to bus 516 to enable microsequencer 504 to transmit and receive data and commands therefrom. Parameter RAM block 544 is random access memory for providing temporary storage of data. Hardware registers block 548 comprises a plurality of accessible registers that are also used for storing data and/or computer instructions.

Similarly, TX audio block 552, TX data FIFO 556 and E-Buffer block 560 also are coupled to bus 518 to communicate with microsequencer 504. E-Buffer 560 further is coupled to receive radio transmissions from radio RX block 564. Bus 518 is coupled to produce communication signals to logic gate 568 that is also coupled to receive bits from CRC FEC Whiten encryption block 572.

In operation, a signal stream that is to be transmitted is received from external radio circuitry (not shown) at TX audio block 552 or TX data FIFO block 556. The signal is conducted along bus 518, through logic gate 568 to microsequencer 504. Microsequencer 504, in turn, processes the signal and outputs it to logic gate 540 where it is logically combined with the outputs of CRC FEC Whitten Encryption module 536. The output of the logic gate 540 is then produced to bus 508 which conducts the signal to E-Buffer 528 and radio TX block 532 for transmission.

Received transmission signals are processed in a similar manner. A received signal is conducted into radio RX block 564 for initial processing and then into E-Buffer 560. E-Buffer 560 produces the signal to logic gate 568 by way of bus 518 where it is logically combined with the output of CRC FEC Whitten Encryption module 572 that decodes the signal (among other functions). The received signal is then conducted through microsequencer 504 which then processes it and produces it to either RX audio block 520 or RX data FIFO block 524 for further audio processing.

FIG. 6 is a functional block diagram illustrating a plurality of memory structures formed according to one embodiment of the present invention. A FIFO pointer block memory structure 604 includes a plurality of command block pointers 608, 612, 616 and 618 (pointers to command blocks). Each command block pointer identifies a command block within a command block array 620. As may be seen, command block array 620 includes three data block pointers 624, 628, 632 and 634 that each point to one of a plurality of data blocks stored within data memory 636. Thus, in the example shown, there exists within data memory 636 at least four memory portions 640, 644, 648 and 650 that store data blocks 1, 2, 3 and 4, respectively.

From examining FIG. 6, it may be seen that FIFO pointer block memory structure 604 includes the command block pointers that may be arranged in any order to point to one of a plurality of data block pointers stored within command block array 620. Data transmissions occur, therefore, in a sequential order (e.g., top to bottom in the example shown) The FIFO priority is obtained by arranging the command block pointers within FIFO pointer block memory structure 604 to create the ordered priority. Given that the priority rule is first in, first out, the command block pointers within FIFO pointer block memory structure 604 are ordered in the order received.

Thus, the priority for the data blocks is achieved by ordering the command block pointers within FIFO pointer block memory structure 604. Because the command block pointers 608, 612 and 616 within FIFO pointer block memory structure 604 point to one of a plurality of data block pointers within command block array 620, wherein the data block pointers actually identify the starting address of a data block, a flexible structure is presented in which FIFO integrity or ordering may be achieved while minimizing the size of a FIFO memory structure.

To give a more specific example, command block pointer 608 of FIFO pointer block memory structure 604 includes a pointer to data block pointer 628 that is stored within command block array 620. Data block pointer 628, in turn, points to data block 3 within memory portion 648 of data memory 636. Command block pointer 612, however, points to data block pointer 632 which, in turn, points to data block 2 within memory portion 644. Finally, command block pointer 616 points to data block pointer 624 of command block array 620 which, in turn, points to data block 1 stored in memory portion 640 of data memory 636. As may be seen in the present example, data block 3, which is stored in a memory location that suggests, perhaps, third in time based on its relative placement, actually represents the highest priority data block for transmission purposes based upon the ordering of the command block pointer 608 that eventually corresponds to data block 3 stored in memory portion 648.

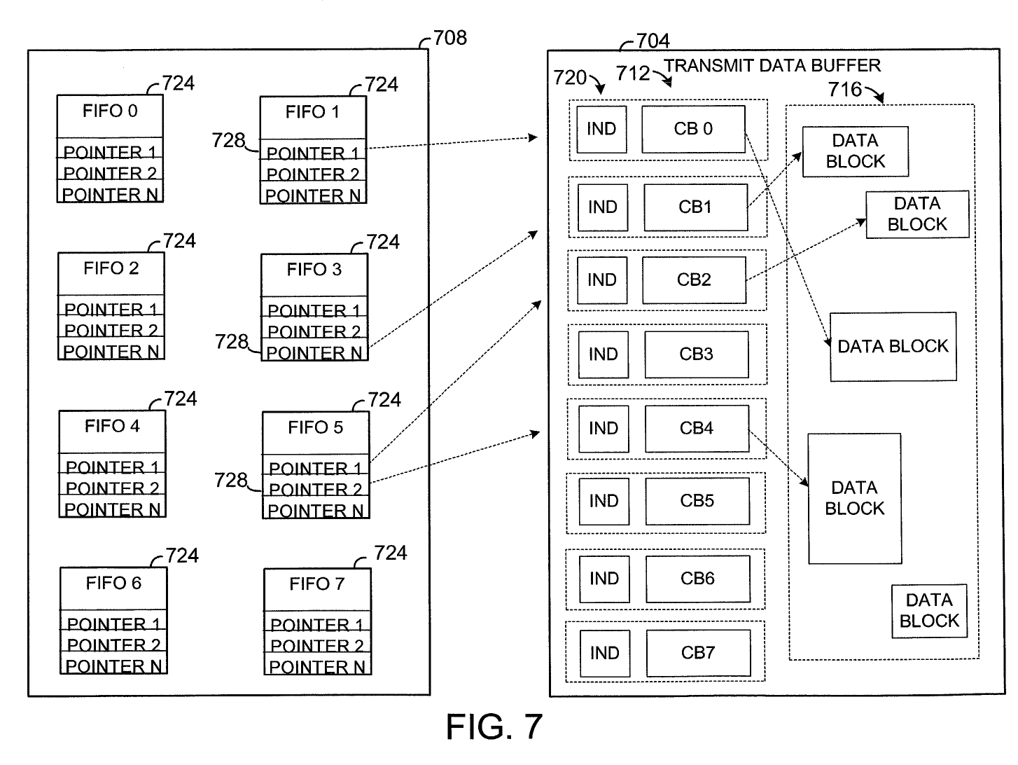

FIG. 7 is a functional block diagram illustrating one embodiment of memory structures formed and configured according to the present invention. A random access memory 704 is configured to include at least three portions. A FIFO structure 708 is formed to interact with the random access memory 704 to support the transmission of data blocks on a first in, first out basis. More specifically, random access memory 704 includes a command block portion 712 that is for storing command blocks. Each command block is four bytes long and includes an address that points to an actual data block that is to be transmitted. A data block portion 716 includes actual data blocks that are to be transmitted. In the figure shown, the data blocks are randomly distributed within the figure to suggest that the data blocks may be ordered in a random fashion. Each data block within data block portion 716 includes the data, which data may be of any size, as well as header information that defines, among other things, the amount of data that corresponds to the data block. An indicator portion 720 of random access memory 704 is for storing a plurality of indicators, each of which is one bit long in the described embodiment, that identify whether a corresponding command block is in use. For example, command block 0 of portion 712 will have a one-bit indicator in indicator portion 720 that identifies whether the command block is in use. In the described embodiment of the invention, “in use” refers to whether a transmission has been successfully completed for a corresponding data block stored in data block portion 716. Thus, once a data block has been successfully transmitted, the indicator for the corresponding data block is reset to indicate that the command block is no longer in use and that a new data block address may be inserted therein for a new data block that is being stored within data block portion 716.

Within FIFO structure 708, a plurality of FIFO pointer blocks 724 are used for specifying the order in which data blocks are to be transmitted. In the example shown, eight FIFO pointer blocks 724 are shown. Each FIFO pointer block 724 includes at least one-byte pointer 728. The at least one-byte pointer 728 is a one-byte long pointer that points to a corresponding command block that identifies an address of a data block that is to be transmitted. Thus, within each FIFO pointer block 724, a series of data blocks may be ordered in a first in, first out basis. Each of the FIFO pointer blocks 724 further corresponds to communications for a particular device, e.g., a slave device. Thus, the present architecture decouples the transmissions of the slaves relative to each other. Stated differently, traffic to all the slaves are independent and may be controlled independently of each other with the present architecture. Thus, for example, if the traffic for a first slave encounters an error, the traffic to any other slave is not affected as retransmissions occur for the first slave. Moreover, in the described embodiment of the invention, there are eight FIFO pointer blocks 724, as well as eight command blocks within command block 712 and eight indicators within indicator portion 720. The number of data blocks within data block portion 716, however, is not tied to the number of FIFO pointer blocks 724 and command blocks within command block portion 712. Rather, the number of data blocks within data block portion 716 is a function of the number of data blocks that are to be transmitted. As was indicated with reference to FIFO structure 708 and, more particularly, the FIFO pointer block 724, each FIFO pointer block 724 may have an indeterminate number of one-byte pointers to command blocks listed in a transmission order (FIFO).

As may be seen, the present configuration is advantageous in that is supports FIFO ordering of traffic to a plurality of slaves in a manner that avoids delays to a plurality of slaves based on transmission errors to one slaves, and in a manner that significantly reduces the cost associated with FIFO structures by minimizing the size of the FIFO structure. The particular configuration is advantageous for networks in which a master communicates with two or more slaves.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A wireless transceiver device, comprising:
modulation circuitry for modulating and demodulating signals that are transmitted over the airwaves;
frequency conversion circuitry for up converting and down converting between radio frequency signals and baseband frequency signals;
digital-to-analog conversion circuitry for converting from analog to digital and from digital to analog;
a radio controller; and
baseband processing circuitry including a first in, first out memory structure for storing addresses for accessing data blocks.

2. The wireless transceiver of claim 1 further including a plurality of command blocks formed within a memory structure, which command blocks include addresses of data blocks stored within random access memory.

3. The wireless transceiver of claim 2 wherein the first in, first out memory structure includes pointers that define addresses of the command blocks.

4. The wireless transceiver of claim 2 further forming a memory portion for storing an indicator for indicating whether a command block is in use.

5. The wireless transceiver of claim 1 wherein the modulation circuitry includes GPSK modulation and demodulation circuitry.

6. The wireless transceiver of claim 1 wherein the frequency conversion circuitry converts directly between RF and baseband.

7. A method for storing and transmitting data, comprising:
storing a data block in random access memory; and
storing a pointer that corresponds to the data block in a first in, first out memory structure.

8. The method of claim 7 wherein the pointer comprises an address of a command block.

9. The method of claim 8 further including the step of storing an address of the data block in the command block.

10. The method of claim 9 further including the step of setting a signal in a defined memory location, which signal indicates that the address in the command block is for data that has yet to be successfully transmitted and therefore that the command block is busy.

11. The method of claim 10 wherein an address for a data block is only stored in a command block if an indicator reflects that the command block does not contain the address of a data block that has yet to be successfully transmitted.

12. The method of claim 7 further including the step of evaluating a command block address stored within a FIFO pointer.

13. The method of claim 12 further including examining the contents of the command block specified by the pointer to determine a data block address.

14. The method of claim 13 further including the step of evaluating at least the first memory location of the data block whose address is specified in the command block to determine the size of the data block.

15. The method of claim 14 further including the step of retrieving an amount of data corresponding to the size data block specified in claim 14 and transmitting that data to a radio modem for transmission over a wireless airwaves.

16. The method of claim 15 further including the step of resetting the indicator signal if the transmission was successful.

17. A memory structure formed within a baseband processing system, comprising:
a random access memory portion for storing data blocks that are to be transmitted in a first in, first out order; and
a first in, first out memory structure for storing pointers that correspond to the data blocks.

18. The memory structure of claim 17 wherein a plurality of command blocks are defined within the random access memory wherein each command block is for specifying an address of a data block that is to be transmitted.

19. The memory structure of claim 18 further including a defined memory portion for storing command block indicators for each command block, which indicators specify whether its corresponding command block includes the address of a data block that has yet to be transmitted successfully.

20. The memory structure of claim 19 wherein the memory portions for storing the indicators are each one bit in length.

21. The memory structure of claim 18 wherein the memory portions for storing the command blocks are each four bytes in length.

22. The memory structure of claim 17 wherein the first in, first out memory structure defines a plurality of first in, first out memory blocks wherein each first in, first out memory relates to data blocks that are to be transmitted to a particular device.
